(19) United States
(12) Patent Application Publication
(10) Pub. No.: US 2007/0271346 A1
(43) Pub. Date: Nov. 22, 2007

(54) Method and System for Filtering Electronic Messages

(76) Inventor: Jean-Louis Vill, Ste-Foy (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/686,249

(22) Filed: Mar. 14, 2007

Related U.S. Application Data
(63) Continuation of application No. PCT/CA05/01368, filed on Sep. 7, 2005.
(60) Provisional application No. 60/609,434, filed on Sep. 14, 2004.

(51) Int. Cl. G06F 15/16

(52) U.S. Cl. 709/206

(57) ABSTRACT

A method for filtering an incoming electronic message sent by a sender and addressed to a user. The method includes providing a first temporary identifier, receiving the incoming electronic message from the sender, processing the incoming electronic message to detect the presence of the first temporary identifier therein, and upon detection of the first temporary identifier, allowing a delivery of the incoming electronic message to the user.

This application claims priority based on provisional application 60/609,434 filed Sep. 14, 2004

### FIELD OF THE INVENTION

The present invention relates to the general field of electronic messaging and is particularly concerned with a method and system for filtering electronic messages.

### BACKGROUND OF THE INVENTION

Electronic messaging is an efficient and relatively inexpensive medium of communication. While these two characteristics are mostly advantageous to its users, they also have generated a nuisance in the form of undesired electronic messages.

For example, in electronic mail messaging (email), it is common to receive a relatively high volume of unsolicited and often undesired messages including predominantly publicity and swindle attempts, commonly known under the name of “SPAM”, and malicious programs, such as viruses and worms, for example.

While it may look like a minor nuisance, SPAM is in fact a major problem. Often, SPAM messages received by a user outnumber legitimate messages. Accordingly, there is a need to spend resources for storing, transmitting and filtering these messages.

Many methods have been proposed to alleviate this problem. Unfortunately, they mostly have proven to be unsatisfactory.

For example, one such method uses rules for filtering incoming mail messages. These rules typically label an incoming electronic mail message as being either a legitimate message or a SPAM message. SPAM messages are automatically deleted or stored separately from legitimate messages. Legitimate messages are stored in an incoming email box and readily accessible by the user.

Unfortunately, none of the proposed method is able to automatically identify correctly all SPAM messages as such and all legitimate messages as such. Since classifying a legitimate message as SPAM usually has much worse consequences than classifying a SPAM message as legitimate, these rules typically leave at least a few SPAM messages to be delivered to the incoming email box of the user.

In addition, those who send SPAM, the SPAMMERS, typically monitor and analyze the software used to implement the rules to write and send the SPAM such that it is classified as legitimate.

Another method for reducing SPAM includes only publicizing one's email address to certain other email users from whom emails are desired. Unfortunately, using this method prevents email users other that the certain other email users to send email messages that are properly delivered. Accordingly, this method is of limited use for many businesses and is at most useful in very specific settings. Also, if for any reason the secret email address becomes known to a SPAMMER or to a party that provides email addresses to SPAMMERS, the address becomes useless as a secret address and must be discarded.

In a related method, an identifier is associated with the address. The identifier is distributed only to trusted parties from which the reception of email messages is desired. The identifier in included in email messages sent by these parties. Only email messages including the identifier are delivered to the user's incoming email box. If for any reason the identifier becomes compromised, the user typically modifies the identifier and sends the new identifier to the trusted parties. However, as in the “secret email address” method, unknown parties that are potential trusted parties cannot send email messages that are properly received by the user. Also, if a user wishes to use commercial systems for ordering though email or mailing lists, for example, the identifier needs to be publicized and is likely to find its way to SPAMMERS.

In another method, there is no identifier and the user maintains a list of trusted parties, either manually or with the help of software-implemented heuristics. Incoming email messages are delivered only if they come from a trusted party. Once more, unknown parties that are potential trusted parties cannot send email messages that are properly received by the user.

To try to circumvent this problem, an additional step is performed. Instead of automatically discarding messages coming from unknown parties, a reply message is sent in response to the incoming message, the reply message including a challenge that is designed to be relatively easily answered by a person and relatively hardly answered by a machine. The incoming email message is delivered to the user's inbox only if a satisfactory response to the challenge arrives within a predetermined time interval. This method is based on the fact that SPAMMERs typically forge a reply address. Accordingly, a SPAM message will never receive a reply to the challenge. Also, even if the reply address is legitimate, it would typically be economically unfeasible to have a person replying to all challenge messages as response rates to SPAM are typically very small.

A disadvantage with this method occurs when two users, say A and B each use an email system that implements the challenge method. In this case, if for example A writes and email to B, and A is not a trusted party for B, B will reply with a challenge. However, because B may not be a trusted party for A, A will also reply with a challenge to the challenge. This creates an endless loop wherein A and B will never exchange content through email.

Accordingly, there exists a need for new and improved methods and devices for filtering electronic messages.

### OBJECTS OF THE INVENTION

An object of the present invention is therefore to provide an improved method and device for filtering electronic messages.

### SUMMARY OF THE INVENTION

In a first broad aspect, the invention provides a method for filtering an incoming electronic message sent by a sender and addressed to an intended user. The method includes providing a first temporary identifier, receiving the incoming electronic message from the sender, processing the incoming electronic message to detect the presence of the first temporary identifier therein, and upon detection of the first temporary identifier, allowing a delivery of the incoming electronic message to the user.

Electronic messages are any types of digital messages that are distributed to receivers identified by an address. They include electronic mail messages, transmitted through the Internet, airwaves or any other suitable medium. However, they also include other types of messages, such as for example and non-limitatively instant messaging messages transmitted through the internet or through a cellular phone network, audio messages (including telephone calls), facsimile messages, video messages and Internet Relay Chat (IRC) messages.

A temporary identifier is an identifier, for example a string of characters, an image, or any other suitable identifier, that is provided by the user or by a machine used by the user for the purpose of performing the above-described method. The identifier is temporary because it is detectable only for a limited amount of time. After this amount of time, the identifier is no longer recognized as a temporary identifier by the method and any message including the invalid temporary identifier is not allowed to be delivered to the user.

Advantageously, the inclusion of a temporary identifier in an outgoing electronic message allows to protect the user's address while allowing to receive replies to outgoing messages. Since the temporary identifier is changed relatively frequently, it is of very limited use to SPAMMERS and other parties wishing to send undesired messages to the user.

In addition, the method is relatively simple and therefore relatively easy to implement.

In a variant, the electronic message is an electronic mail message and the identifier is included in a field of a header or the message that is typically transmitted when sending or replying to a message. Accordingly, a receiver receiving a message including the first temporary identifier from the user and replying to the message relatively fast, while the temporary identifier is detectable, will see the reply accepted for delivery to the user as the first temporary identifier is present in the reply.

This variant is particularly advantageous as it allows to implement the method without requiring that a particular new standard be accepted. Indeed, the currently accepted electronic mail infrastructure is already configured with little or no change to allow the use of the method in this variant.

In a further variant, the identifier is included in a dedicated field in the electronic mail message, for example in a dedicated field in the header of the electronic mail message.

In another broad aspect, the invention provides a method for filtering an electronic mail message sent by a sender and addressed to an intended user. The method includes providing a first temporary identifier and a predetermined identifier, receiving an incoming electronic mail message from the sender, processing the incoming electronic mail message to detect the presence of at least one of the first temporary identifier and predetermined identifier therein, upon detection of the at least one of the first temporary identifier and predetermined identifier, allowing a delivery of the incoming electronic mail message to the user, upon an absence of the first temporary identifier and of the predetermined identifier in the incoming electronic mail message, storing the incoming electronic mail message and sending a challenge message associated with the stored electronic message to the sender, wherein the challenge message is designed to be answered by a person and not a machine, the challenge message including a challenge.

In yet another broad aspect, the invention provides a machine readable storage medium containing a program element for execution by a computing device. The program element is for filtering an incoming electronic message sent by a sender and addressed to an intended user. The program element includes an identifier generating module for providing a first temporary identifier, an input module for receiving the incoming electronic message from the sender, and a filtering module operative for (i) processing the incoming electronic message to detect the presence of the first temporary identifier therein; and (ii) upon detection of the first temporary identifier, allowing a delivery of the incoming electronic message to the user.

In yet another broad aspect, the invention provides a system for filtering an incoming electronic mail message sent by a sender and addressed to an intended user. The system includes an identifier generating means for providing a first temporary identifier, an input means for receiving the incoming electronic mail message from the sender and a filtering means for processing the incoming electronic mail message to detect the presence of the first temporary identifier therein and for, upon detection of the first temporary identifier, allowing a delivery of the incoming electronic mail message to the user.

Other objects, advantages and features of the present invention will become more apparent upon reading of the following non-restrictive description of preferred embodiments thereof, given by way of example only with reference to the accompanying drawings.

### BRIEF DESCRIPTION OF THE DRAWINGS

In the appended drawings

FIG. 1 is a schematic diagram of a system for filtering electronic messages;

FIG. 2 is a schematic diagram of a computing device for executing a program element implementing a method for filtering electronic messages;

FIG. 3 is a schematic diagram of a program element implementing a method for filtering electronic messages; and

FIG. 4 is a flowchart of a method for filtering electronic messages.

### DETAILED DESCRIPTION

Referring to FIG. 1, there is shown in block diagram form a system 10 for filtering an incoming electronic message sent by a sender and addressed to an intended user. In the system 10, the electronic message is an electronic mail messages. However, it is within the scope of the invention to filter other types of electronic messages, such as, for example, instant messaging messages transmitted through the internet or through a cellular phone network, audio messages (including telephone calls), facsimile messages, video messages and Internet Relay Chat (IRC) messages Accordingly, while this document mainly gives specific examples wherein the electronic messages are electronic mail messages, it is within the scope of the invention to have systems that filter any other suitable type of electronic messages and the description given hereinbelow should not restrict the scope of the appended claims to filtering of currently known electronic mail messages.

The system 10 includes a server 12 and one or more clients 14. In the drawings, three clients 14 are shown. However, it is within the scope of the invention to have a system with any number of clients 14. The server 12 and the clients 14 are connected through links 16. The links 16 allow the clients 14 and the server 12 to exchange electronic messages. In some embodiments of the invention, the links 16 are physical links, such as for example metal wires or optical fibers. In other embodiments of the invention, the links 16 are electromagnetic wave links, such as for example infrared links or radio frequency links. In yet other embodiments of the invention, the links 16 include any other suitable type of link.

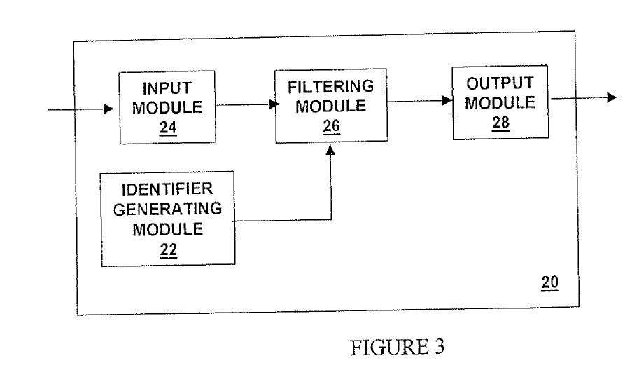

In some embodiments of the invention, the system 10 includes a machine readable storage medium containing a program element 20, illustrated in FIG. 3, for execution by a computing device. In a specific embodiment of the invention illustrated in the drawings, the computing device is the server 12. In alternative embodiments of the invention, the computing device is one of the clients 14 or any other suitable computing device.

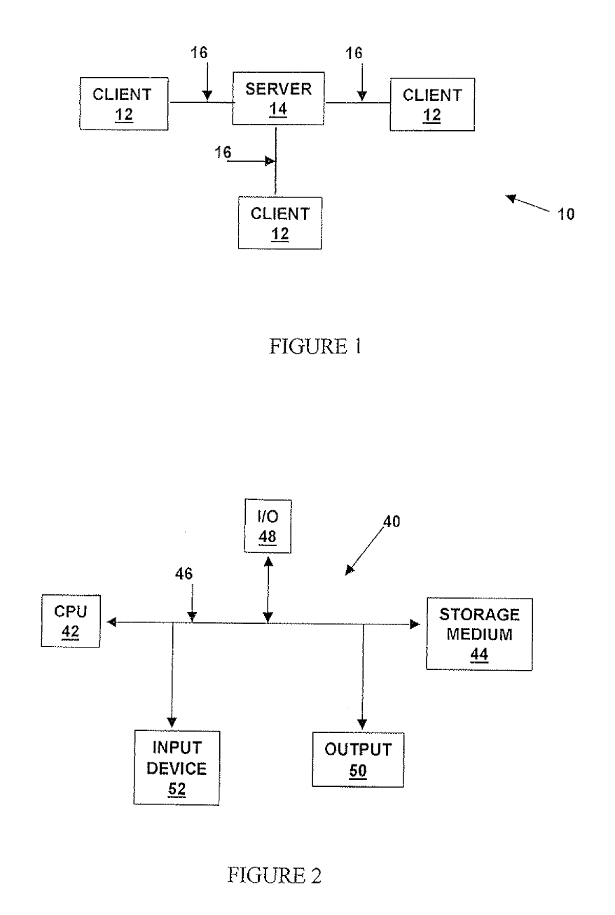

An example of a computing device 40 suitable for executing the program element 20 is illustrated in FIG. 2. However, any other type of suitable computing device is within the scope of the invention. The computing device 40 includes a Central Processing Unit (CPU) 42 connected to a storage medium 44 over a data bus 46. Although the storage medium 44 is shown as a single block, it may include a plurality of separate components, such as a floppy disk drive, a fixed disk, a tape drive and a Random Access Memory (RAM), among others. The computing device 40 also includes an Input/Output (I/O) interface 48 that connects to the data bus 46. The computing device 40 communicates with outside entities through the I/O interface 48. In a non-limiting example of implementation, the I/O interface 48 includes a network interface connected to one of the links 16.

The computing device 40 also includes an output device 50 to communicate information to a human. In the example shown, the output device 50 includes a display. Optionally, the output device 50 includes a printer or a loudspeaker. The computing device 40 further includes an input device 52 through which the user may input data or control the operation of a program element executed by the CPU 42. The input device 52 may include, for example, any one or a combination of the following: keyboard, pointing device, touch sensitive surface or speech recognition unit.

When the computing device 40 is in use, the storage medium 44 holds a program element 20 (see FIG. 3) executed by the CPU 42, the program element 20 implementing a method for filtering the electronic message sent by the sender and addressed to the user.

The program element 20 is for filtering the incoming electronic message sent by the sender and addressed to the user. The program element 20 includes an identifier generating module 22 for providing a first temporary identifier, an input module 24 for receiving the electronic message from the sender and a filtering module 26 operative for (i) processing the incoming electronic message to detect the presence of the first temporary identifier therein; and (ii) upon detection of the first temporary identifier, allowing a delivery of the incoming electronic message to the user. The filtering module 26 receives the incoming electronic message from the input module 24 and the first temporary identifier from the identifier generating module 22.

In some embodiments of the invention, the program element 20 includes an output module 28 for delivering electronic messages to an electronic message interface. The output module 28 receives electronic messages from the filtering module 26.

The user interacts with one of the clients 14. To that effect, this client 14 is for executing an electronic message interface, such as for example an electronic mail interface. A specific and non-limitative type of electronic mail interface is an electronic mail reader program. In this case, a suitable client 14 is a computing device similar to the computing device 40. Accordingly, the client 14 includes, for example, an output for displaying electronic mail messages to the user and an I/O port for receiving and releasing electronic mail messages. Therefore, the output module 28 delivers electronic messages to the electronic message interface through the I/O port of the client 14.

Although in one aspect the present invention is related to a client-server system wherein a filtering functionality is provided on a server, it is also within the scope of the invention to have systems wherein the computing device that executes the program element 20 is a client 14. Also, in other embodiment of the invention, a peer-to-peer system is used wherein there is no server 12. In yet other embodiments of the invention, the program element is executed by a computing device that is included in any other suitable type of system.

Also, the program element 20 is either a stand-alone program element, a plug-in program element, a sub-routine included in a program element or a portion of an operating system for the computing device 40, among others. Accordingly, the program element 20 takes many different forms in alternative embodiments of the invention.

In addition, while specific modules have been identified as being included in the program element 20, the reader skilled in the art will readily appreciate that such modules do not necessarily correspond to distinct instruction sets in the program element 20. More specifically, the above-describes structure should not be interpreted as restricting in any manner the internal structure of the program element 20. Accordingly, the program element 20 is not necessarily programmed using a structured programming language wherein each module corresponds to a specific procedure or sub-routine.

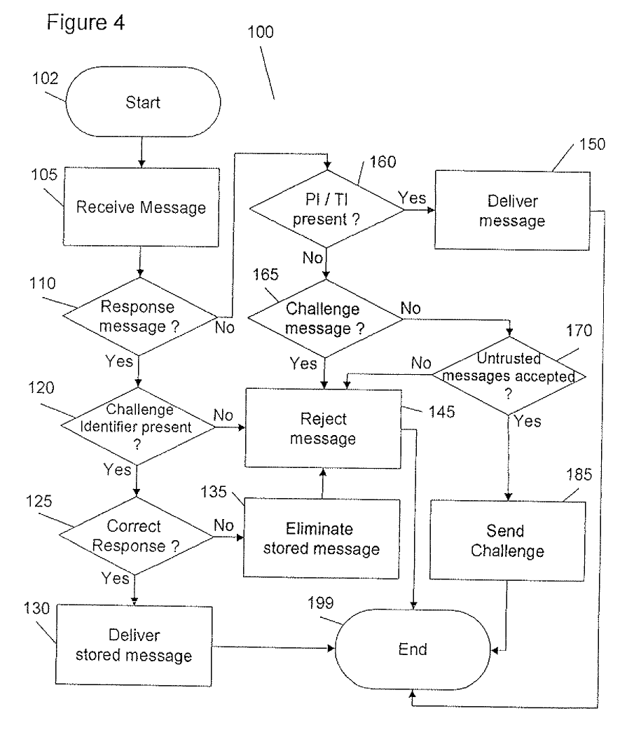

The system 10 implements a method 100, illustrated in flowchart form in FIG. 4, for filtering an incoming electronic message sent by a sender and addressed to an intended user. Briefly, the method includes the steps of:

a. providing a first temporary identifier;

b. receiving an incoming electronic message from the sender;

c. processing the incoming electronic message to detect the presence of the first temporary identifier therein; and

d. upon detection of the first temporary identifier, allowing a delivery of the incoming electronic message to the user.

In an alternative aspect, the system 10 implements a method for filtering an incoming electronic mail message sent by a sender and addressed to a user, the method including:

a. providing a first temporary identifier and a predetermined identifier;

b. receiving an incoming electronic message from the sender;

c. processing the incoming electronic message to detect the presence of at least one of the first temporary identifier and predetermined identifier therein;

d. upon detection of the of at least one of the first temporary identifier and predetermined identifier, allowing a delivery of the incoming electronic mail message to the user;

e. upon an absence of the first temporary identifier and of the predetermined identifier in the electronic mail message, storing the incoming electronic mail message and sending a challenge message associated with the stored electronic message to the sender, wherein the challenge message is designed to be answered by a person and not a machine, the challenge message including a challenge.

In yet another aspect, the invention relates to a system for filtering an incoming electronic mail message sent by a sender and addressed to an intended user. The system includes an identifier generating means for providing a first temporary identifier, an input means for receiving the incoming electronic mail message from the sender and a filtering means for processing the incoming electronic mail message to detect the presence of the first temporary identifier therein and for, upon detection of the first temporary identifier, allowing a delivery of the incoming electronic mail message to the user.

FIG. 4 illustrates an example of the method 100 for filtering electronic messages in accordance with the invention. The reader skilled in the art will appreciate that many other alternative methods are within the scope of the invention, some of which are variants of the method 100.

In the following text, the epithet electronic relating to messages is omitted to improve readability. However, it should be understood that unless otherwise specified, all messages referred-to hereinbelow are electronic messages.

The method starts at step 102. At step 105, an incoming message is received from a sender by the input module 24. At step 110, the filtering module 26 verifies if the incoming message is a response message sent in response to a challenge message. Briefly, challenge messages are messages that are sent upon the reception of a message from an untrusted party, which is a party that is not authorized yet to send messages to the user, to verify that the untrusted party is a human and not an automated mailing list system. A challenge message is associated with a stored message that is delivered to the user upon a correct response to the challenge. The emission and content of challenge messages are described in further details hereinbelow.

If the incoming message is a response message, the filtering module 26 verifies at step 120 if a challenge identifier is present in the response message, the challenge identifier being associated with a previously sent challenge message. If the challenge identifier is not present, the filtering module 26 jumps to step 145 and rejects the response message, further to which the method 100 ends at step 199.

If the challenge identifier is present, the filtering module 26 jumps to step 125 and verifies that the response message includes a correct response to the challenge. If the response message includes a correct response to the challenge, the electronic message associated with the challenge message to which the response message relates is allowed to be delivered to the user's electronic message interface at step 130 and the method ends at step 199. Actual delivery is performed by the output module 28.

If the response message includes an incorrect response to the challenge, the stored message associated with the challenge message to which the response message relates is eliminated at step 135 and the incoming message is rejected at step 145. Then, the method ends at step 199.

Returning to step 110, if the incoming message is not a response message, the method jumps at step 160 wherein the filtering module verifies if either of a temporary identifier or a predetermined identifier is present in the incoming message. If either of the predetermined or temporary identifiers is present, the method jumps to step 150 wherein the electronic message is allowed to be delivered to the user and the method ends at step 199. Otherwise, the method jumps to step 165.

At step 165, the filtering module 26 verifies if the incoming message is a challenge message from another party. In the affirmative, the method jumps to step 145 wherein the incoming message is rejected and the method ends at step 199. Otherwise, the method jumps to step 170.

At step 170, the filtering module 26 verifies if messages from untrusted parties are to be eventually delivered to the user further to a correct response to a challenge. If not, the method jumps to step 145 wherein the incoming message is deleted. Otherwise, the method jumps to step 185 wherein the filtering module 26 stores the incoming message in the storage medium 44 and sends a challenge message to the untrusted party through the I/O port 28. In some embodiments of the invention, the filtering module 26 searches at step 185 for a temporary identifier from the untrusted party in the incoming message and ensures that the temporary identifier from the untrusted party is included in the challenge message. Then, processing of the incoming message is completed and the method ends at step 199.

To better understand the above-described method 100, an example of a context wherein the method 100 is usable is described hereinbelow. The predetermined identifier and the temporary identifier are identifiers that are included in at least some electronic messages sent by the user.

The predetermined identifier is typically provided by the user and publicized only to trusted parties from which the user wishes to receive electronic messages. For example, the predetermined identifier is received from the user through prompting the user upon a first use of the system 10 by the user. In some embodiments of the invention, a plurality of predetermined identifiers are used, each predetermined identifier being associated with one or more senders. In this case, a predetermined identifier is valid only when present in an electronic message sent by its associated sender(s).

Also, in some embodiments of the invention, the predetermined identifier is modifiable by the user through the electronic message interface. In this case, some embodiments of the invention allow for automatically sending an identifier update message to each destination present in the predetermined list of destinations further to an instruction from the user to change the predetermined identifier to new predetermined identifier, the identifier update message including the new predetermined identifier. This action allows to update the predetermined identifier to a new identifier and to automatically send the new identifier to other parties for which the destination is present in the predetermined list of destinations, for example to parties for which an electronic mail address is present in a contacts list.

In a non-exclusive manner of publicizing the predetermined identifier, the predetermined identifier is included in an electronic message sent by the user to a trusted party. In another non-exclusive manner of publicizing the predetermined identifier, the predetermined identifier is communicated to the trusted party through a non-electronic message, such as for example through a business card including the predetermined identifier or through a telephone conversation. In other non-exclusive manners of publicizing the predetermined identifier, the predetermined identifier is publicized through a Web site in a text format or through an image, a script, an audio signal or a video signal, among others. Then, if the trusted party includes the predetermined identifier in electronic messages sent to the user in a suitable manner, the method 100 will detect the predetermined identifier and allow delivery of these electronic messages.

In some embodiments of the invention, the electronic message interface includes the predetermined identifier in outgoing messages sent by the user that satisfy at least one predetermined diffusion criteria. An example of such a diffusion criteria is “sending the outgoing message to a destination present in a predetermined list of destinations”, which is non-limitatively a contacts list, such as a contact list managed by the electronic message interface or a remotely stored contact list. Lists of destinations and contact lists are well-known in the art and will not be described in further details.

Another example of a diffusion criteria includes a reception of an inclusion command from the user, given for example through selection of an appropriate input field in the electronic message interface. Any other suitable diffusion criteria is also within the scope of the invention.

The temporary identifier is generated by the identifier generating module 22 and is modified relatively frequently. Further to their generation, temporary identifiers are stored for use by the method 100 only over a relatively short time interval in the storage medium 44. Therefore, the method 100 only allows delivery of messages including recently generated temporary identifiers. For example, the method 100 only accepts the last generated temporary identifier and the second-to-last generated temporary identifier.

In some embodiments of the invention, the temporary identifier is automatically updated at random time intervals. In other embodiments of the invention, the temporary identifier is automatically updated at a fixed time interval. Examples of a fixed time interval include one hour, one day or one week, among others. In yet other embodiments of the invention, the system 10 prompts the user at random or predetermined time intervals for new temporary identifiers to use and uses for a new temporary identifier the identifier thereby provided.

In some embodiments of the invention, the temporary identifier is included in an outgoing message only if the predetermined identifier is excluded from the outgoing message. In other embodiments of the invention, the temporary identifier is included in every outgoing message sent by the user.

In some embodiments of the invention, the temporary identifier includes a string of characters or at least one symbol, which can be a video or sound information, that is used explicitly for the purpose of being the temporary identifier. In other embodiments of the invention the temporary identifier is indicative of a moment at which an electronic message was sent, a destination to which an electronic message was sent, of a content of an electronic message that was sent, or of any combination thereof. In the case of an electronic mail message, a combination of a destination electronic mail address, a subject of the electronic mail message and a time at which the electronic mail message was sent is therefore an example of a suitable temporary identifier.

In a specific example of implementation, the electronic message is an electronic mail message. Typically, such messages include a header containing information about the source and the destination of the message, among others. Also, these messages include a body including information to be transmitted through the message.

The source and destination information typically each include an address identifying respectively the sender and the receiver of the message and are present respectively in source and destination fields in the message. An example of a source field includes a “from” field while examples of destination fields include “to” “CC” and “BCC” fields (CC: Carbon Copy, BCC: Blind Carbon Copy). In addition, the source and destination information typically each include an alias related respectively the sender and the receiver of the message. An example of such an alias is a string of characters spelling a name of the sender or of the receiver.

In this context, it is advantageous in some embodiments of the invention to include an identifier, such as a predetermined or a temporary identifier, in an alias. For example, the identifier is appended to the alias related to the name of the sender when sending an outgoing message. Therefore, if a receiver replies to the message before the temporary identifier is deleted from the sender's system, the sender will very likely receive the temporary identifier in the reply message as typically electronic mail interfaces include the alias information as well as the address information for the sender in a reply to a message.

Therefore, the sender is able to receive replies to the outgoing message without publicizing his predetermined identifier. Accordingly, this reply is only delivered to the sender for a certain time interval. If the reply is sent after this time interval, the reply is rejected.

This behavior is useful in many contexts. For example, and non-limitatively, a user buying an item from a supplier through electronic mail is able to receive, still trough electronic mail, a confirmation that an order is placed, as these confirmations are typically sent very shortly after the reception of the order. However, contrary to what would happen if the predetermined identifier were to be included in such an order, the supplier cannot use the temporary identifier to SPAM the sender as the temporary identifier becomes invalid after a relatively short time interval.

In other embodiments of the invention, the identifier is included in a dedicated field in the electronic mail message, for example in a dedicated field in the header of the electronic mail message.

In another non-limitative context, if the sender, who receives electronic mail messages through the system 10, sends an outgoing message to a receiver who receives electronic mail messages through a system similar to the system 10 and includes the sender's temporary identifier in the outgoing message, the system of the receiver will be able to send a challenge message that will be delivered to the sender if the challenge message includes the sender's temporary identifier. Otherwise, the challenge message would not be delivered and communication would at best stop of at worst create an endless loop of challenge messages being sent in response to challenge messages.

A challenge message is a message that is designed to be answered by a person and not a machine, the challenge message including a challenge. Such challenge messages are well-known in the art. For example, the challenge includes an image of a word written with letters that are crossed or otherwise altered. In addition the challenge message includes instructions on the way to respond to the challenge. A human easily recognizes the word and follow the instructions to retype the word at an appropriate location in a response message. Upon reception of the response message by the system 10, the detection of the response in the response message is relatively easy to perform automatically. Such challenges are typically very difficult to respond to correctly by machines. There exist many other types of suitable challenge messages that are usable in conjunction with the invention.

In some embodiments of the invention, challenge messages are used to delude spammers. An example of such a delusion occurs if, the incoming message is rejected according to criteria that differ from the presence or the absence of identifiers such as those described hereinabove. Such criteria for filtering incoming messages are well-known in the art. However, a challenge message is nevertheless sent but includes an invalid challenge identifier. Accordingly, if the spammer responds to the challenge message, the challenge message is deleted, even if the response is correct. This delusion attempts at increasing the cost of sending spam for the spammer such as to make spamming less attractive.

In view of the above definitions and precisions, some of the steps in the method 100 are commented and expanded upon herein below.

At step 110, the filtering module 26 verifies if the incoming message is a response message sent in response to a challenge message. In some embodiments of the invention, this verification is performed through the detection of a second temporary identifier. Such second temporary identifiers are included in challenge messages sent at step 185.

In other embodiments of the invention, this verification is performed through the detection of a suitable portion of the incoming message that matches any suitable manner of identifying a challenge message. For example, such a suitable portion is a subject field in a header of an electronic mail message including a challenge-specific string that identifies messages as challenge responses.

At step 120, the filtering module 26 verifies if a challenge identifier is present in the response message, the challenge identifier being associated with a previously sent challenge message. The challenge identifier includes a key that associates the challenge response to a previously sent challenge message. The challenge identifier is either directly associated with the previously sent challenge message or indirectly associated with a stored message that itself is associated with the previously sent challenge message.

Indeed, to be of any use, the challenge message must typically include a challenge that is not constantly the same. To be able to verify that a correct response to the challenge is included in the response message, the challenge identifier is included in the sent challenge message. Advantageously, this allows to retrieve the correct challenge response associated with a specific challenge message without including the challenge response in the challenge message. Accordingly, a challenge identifier is associated with each challenge and each stored message. The correct response to the challenge is detected in the response message at step 125 by looking for the challenge response associated with the challenge identifier present in the response message. Methods and data structure for associating messages, challenge responses and challenge identifiers are well-known in the art and will not be further detailed herein.

If there is an incorrect response to the challenge is the response message, at step 135 the stored message is eliminated and the incoming message is rejected. In some embodiments of the invention, an absence of a response is an incorrect response. However, there may be more than one correct response to a challenge. For example, if the response is the number 4, the following strings may be acceptable responses “4”, “four”, “Four” and “FOUR”, among others.

In some embodiments of the invention, the challenge includes a question that only persons familiar with the user would know the answer to.

At step 135, and at step 145, eliminating a stored message and rejecting an incoming message include any suitable manner of processing these messages. For example, they include deleting permanently the message from the system 10, moving the message to a specific location in the system 10 for further use by an administrator of the system 10, including a mention of the elimination and/or rejection in a log file, or any other suitable action. These actions are well-known in the art and will not be described in further details.

At step 160, the presence of the predetermined or of the temporary identifier is detected. However, the presence of the predetermined identifier is only an example of a predetermined input filtering criteria. Upon satisfaction of the predetermined input filtering criteria, at step 150 the incoming message is allowed to be delivered to the user. Another example of such a criteria is the detection of a sender for the message that is included in the predetermined list of destinations.

At step 185, when the incoming message is not a response message and does not include the primary or the temporary identifier, a challenge message is sent. The incoming message is stored, and therefore becomes a stored message. The stored message will be delivered to the user upon a reception of a correct response to the challenge included in the challenge message. A key associated with the challenge, in the form of a challenge identifier, is sent along with the challenge in the challenge message. Accordingly, a challenge, a stored message and a key are associated together.

In some embodiment of the invention, a second temporary identifier is included in the challenge message and a response message including the second temporary identifier is accepted at steps 110 or 120 only if the second temporary identifier is still present in the system 10. In other words, since temporary identifiers are only valid for a limited amount of time, the response message is only accepted for this limited amount of time. In this case, in some embodiments of the invention, the response message is identified as being a response message through the presence of the second temporary identifier in the response message at step 110.

In alternative embodiments of the invention, the response message is identified through the presence of a generic challenge identifier in the response message, which is a fixed identifier.

In other embodiments of the invention, the challenge message includes the first temporary identifier. Accordingly, there is no need in theses embodiments to generate temporary identifiers for the sole purpose of sending and receiving challenge messages and the response thereof.

Optionally, in some embodiments of the invention, step 130 of allowing a delivery of the stored message also includes adding the sender of the response message to the predetermined list of destinations if the response message includes a correct response to the challenge.

In some embodiments of the invention, the presence of a permanent identifier unalterable by the user is also sufficient to allow delivery of the message at step 160. For example, the permanent identifier is provided by a distributor or retailer of the program element 20. The permanent identifier provides a “back door” that is usable by a privileged party to send targeted information. Examples of use of the “back door” are the issuance of advertisements to the user and the issuance of messages including information relevant to the program element 20, such as examples regarding tips for using the program element 20 or information regarding new releases of the program element 20. The permanent identifier need not be totally permanent and in some embodiments of the invention some parties, for example the privileged party, can modify if desired the permanent identifier through a suitable message sent to the program element 20.

In some embodiments of the invention, the permanent identifier is removed from the message before being delivered, such as to prevent the user from filtering out messages including the permanent identifier. In other embodiments of the invention, the permanent identifier is modifiable by an authorized party, for example by the distributor or retailer of the program element 20.

In some embodiments of the invention, the program element 20 is a self-promoting program that adds in outgoing messages a promotional message regarding the program element 20. In other embodiments of the invention, the program element 20 is a self-distributing program that distributes a copy of itself, for example through an attachment to an electronic mail message, upon a request sent in response to the promotional message. Methods and devices to implement such self-promoting and self-distributing messages are well-known in the art and will therefore not be described in further details herein.

Although some specific functions of the program element 20 are presented hereinabove, this description should not be interpreted as being limitative and the program element 20 includes other functionalities in other embodiments of the invention.

Although the present invention has been described hereinabove by way of preferred embodiments thereof, it can be modified, without departing from the spirit and nature of the subject invention as defined in the appended claims.

What is claimed is:

1. A method for filtering an incoming electronic message sent by a sender and addressed to an intended user, said method comprising the steps of:
a. providing a first temporary identifier;
b. receiving the incoming electronic message from the sender;
c. processing the incoming electronic message to detect the presence of the first temporary identifier therein; and
d. upon detection of the first temporary identifier, allowing a delivery of the incoming electronic message to the user.

2. A method as defined in claim 1, further comprising the steps of:
a. providing at least one predetermined input filtering criteria, the at least one predetermined input filtering criteria being different from a detection of the presence of the first temporary identifier in the incoming electronic message;
b. processing the incoming electronic message to detect the satisfaction of the at least one predetermined input filtering criteria;
c. upon satisfaction of the at least one predetermined input filtering criteria, allowing a delivery of the incoming electronic message to the user.

3. A method as defined in claim 2, wherein the at least one predetermined input filtering criteria includes the presence of a predetermined identifier in the incoming electronic message, the predetermined identifier being different from the first temporary identifier.

4. A method as defined in claim 3, wherein the first temporary identifier is included in at least some of the outgoing electronic messages sent by the user.

5. A method as defined in claim 4, wherein the predetermined identifier is included in outgoing electronic messages sent by the user satisfying at least one predetermined diffusion criteria.

6. A method as defined in claim 5, wherein the at least one predetermined diffusion criteria includes sending an outgoing electronic message to a destination present in a predetermined list of destinations.

7. A method as defined in claim 6, wherein the predetermined list of destinations includes a contacts list.

8. A method as defined in claim 7, wherein the first temporary identifier is included in the outgoing electronic message only if the predetermined identifier is excluded from the outgoing electronic message.

9. A method as defined in claim 4, wherein the predetermined identifier is included in outgoing electronic messages sent by the user upon a reception of an inclusion command from the user.

10. A method as defined in claim 9, wherein the first temporary identifier is included in an outgoing electronic message only if the predetermined identifier is excluded from the outgoing electronic message.

11. A method as defined in claim 4, wherein the first temporary identifier is included in every outgoing electronic message sent by the user.

12. A method as defined in claim 4, further comprising the steps of upon both a non-satisfaction of the at least one predetermined input filtering criteria and an absence of the first temporary identifier in the incoming electronic message:
a. storing the incoming electronic message;
b. sending a challenge message associated with the stored electronic message to the sender, wherein the challenge message is designed to be answered by a person and not a machine, the challenge message including a challenge.

13. A method as defined in claim 12, wherein the challenge message includes a challenge identifier identifying the challenge message as such.

14. A method as defined in claim 13, wherein the challenge message includes the first temporary identifier

15. A method as defined in claim 13, further comprising the steps of:
a. receiving a response message in response to the challenge message, the response message being identified as being a response message through the presence of at least part of the challenge identifier in the response message;
b. delivering the stored message to the user if the response message includes a correct response to the challenge.

16. A method as defined in claim 15, further comprising the step of eliminating the stored message if the response message includes an incorrect response to the challenge.

17. A method as defined in claim 16, wherein an incorrect response to the challenge includes the absence of a response to the challenge.

18. A method as defined in claim 17, further comprising the step of adding the sender to a predetermined list of destinations if the response message includes a correct response to the challenge, wherein outgoing electronic messages sent by the user to a destination included in the predetermined list of destinations all include the predetermined identifier.

19. A method as defined in claim 18, wherein the challenge identifier includes a second temporary identifier.

20. A method as defined in claim 19, wherein the response message is identified as being a response message through the presence of the second temporary identifier in the response message

21. A method as defined in claim 19, wherein the challenge identifier includes a generic challenge identifier.

22. A method as defined in claim 19, wherein the response message is identified as being a response message through the presence of the generic challenge identifier in the response message.

23. A method as defined in claim 22, wherein the response message is identified as being a response message through the presence of both the generic challenge identifier and the second temporary identifier in the response message.

24. A method as defined in claim 23, wherein the incoming electronic message is an electronic mail message.

25. A method as defined in claim 24, wherein the challenge message and the response message are electronic mail messages.

26. A method as defined in claim 25, wherein the first temporary identifier is automatically updated at random time intervals.

27. A method as defined in claim 25, wherein the first temporary identifier is automatically updated at a fixed time interval.

28. A method as defined in claim 25, wherein the second temporary identifier is automatically updated at random time intervals.

29. A method as defined in claim 25, wherein the second temporary identifier is automatically updated at a fixed time interval.

30. A method as defined in claim 25, wherein the predetermined identifier is included in a field of an email message selected from the group including a destination field and a source field.

31. A method as defined in claim 25, wherein the first temporary identifier is included in a field of an email message selected from the group including a destination field and a source field.

32. A method as defined in claim 25, wherein the first temporary identifier is indicative of a moment at which an incoming electronic message was sent.

33. A method as defined in claim 25, wherein the first temporary identifier is indicative of a destination to which an incoming electronic message was sent.

34. A method as defined in claim 25, wherein the first temporary identifier is indicative of a content of an incoming electronic message that was sent.

35. A method as defined in claim 25, further comprising;
a. providing a permanent identifier, the permanent identifier being unalterable by the user;
b. processing the incoming electronic message to detect the presence of the permanent identifier therein;
c. upon detection of the permanent identifier, allowing a delivery of the incoming electronic message to the user.

36. A method as defined in claim 6, further comprising the step of automatically sending an identifier update message to each destination present in the predetermined list of destinations further to an instruction from the user to change the predetermined identifier to new predetermined identifier, the identifier update message including the new predetermined identifier.

37. A method as defined in claim 4, wherein upon a non-satisfaction of the at least one predetermined input filtering criteria, an absence of a first temporary identifier in the incoming electronic message and a previously provided authorization by the user, the method further comprises the steps of:
a. storing the incoming electronic message;
b. sending a challenge message associated with the stored electronic message to the sender, wherein the challenge message is designed to be answered by a person and not a machine, the challenge message including a challenge.

38. A method for filtering an incoming electronic mail message sent by a sender and addressed to an intended user, said method comprising:
a. providing a first temporary identifier and a predetermined identifier;
b. receiving the incoming electronic mail message from the sender;
c. processing the incoming electronic mail message to detect the presence of at least one of the first temporary identifier and predetermined identifier therein;
d. upon detection of the of at least one of the first temporary identifier and predetermined identifier, allowing a delivery of the incoming electronic mail message to the user;
e. upon an absence of the first temporary identifier and of the predetermined identifier in the incoming electronic mail message, storing the incoming electronic mail message and sending a challenge message associated with the stored electronic mail message to the sender, wherein the challenge message is designed to be answered by a person and not a machine, the challenge message including a challenge.

39. A machine readable storage medium containing a program element for execution by a computing device, said program element being for filtering an incoming electronic message sent by a sender and addressed to an intended user, said program element comprising:
a. an identifier generating module for providing a first temporary identifier;
b. an input module for receiving the incoming electronic message from the sender; and
c. a filtering module operative for (i) processing the incoming electronic message to detect the presence of the first temporary identifier therein; and (ii) upon detection of the first temporary identifier allowing a delivery of the incoming electronic message to the user.

40. A machine readable storage medium as defined in claim 39, wherein said program element further comprises an output module for releasing the incoming electronic message for delivery to the user.

41. A machine readable storage medium as defined in claim 39, wherein said filtering module if further operative for:
a. processing the incoming electronic message to detect the satisfaction of at least one predetermined input filtering criteria, the at least one predetermined input filtering criteria being different from a detection of the presence of the first temporary identifier in the incoming electronic message
b. upon satisfaction of the at least one predetermined input filtering criteria, allowing a delivery of the incoming electronic message to the user.

42. A machine readable storage medium as defined in claim 41, wherein the at least one predetermined input filtering criteria includes the presence of a predetermined identifier in the incoming electronic message, the predetermined identifier being different from the first temporary identifier.

43. A machine readable storage medium as defined in claim 42, wherein the first temporary identifier is included in at least some outgoing electronic messages sent by the user.

44. A machine readable storage medium as defined in claim 43, wherein the predetermined identifier is included in outgoing electronic messages sent by the user and satisfying at least one predetermined diffusion criteria.

45. A machine readable storage medium as defined in claim 44, wherein the at least one predetermined diffusion criteria includes sending the outgoing electronic message to a destination present in a predetermined list of destinations.

46. A machine readable storage medium as defined in claim 45, wherein the predetermined list of destinations includes a contacts list.

47. A machine readable storage medium as defined in claim 46, wherein the first temporary identifier is included in the outgoing electronic message only if the predetermined identifier is excluded from the outgoing electronic message.

48. A machine readable storage medium as defined in claim 43, wherein the first temporary identifier is included in every outgoing electronic message sent by the user.

49. A machine readable storage medium as defined in claim 43, wherein said filtering module if further operative for, upon both a non-satisfaction of the at least one predetermined input filtering criteria and an absence of a first temporary identifier in the incoming electronic message:
a. storing the incoming electronic message;
b. sending a challenge message associated with the stored electronic message to the sender, wherein the challenge message is designed to be answered by a person and not a machine, the challenge message including a challenge and a challenge identifier identifying the challenge message as such.

50. A machine readable storage medium as defined in claim 49, wherein:
a. said identifier generating module is further operative for providing a second temporary identifier; and
b. the challenge message includes the second temporary identifier.

51. A machine readable storage medium as defined in claim 50, wherein the challenge message includes the first temporary identifier

52. A machine readable storage medium as defined in claim 51, wherein:
a. said input module is further operative for receiving a response message in response to the challenge message;
b. said filtering module is further operative for identifying the response message as being a response message through the presence of at least part of the challenge identifier in the response message and for allowing a delivery of the stored message to the user if the response message includes a correct response to the challenge.

53. A machine readable storage medium as defined in claim 52, wherein said filtering module is further operative for eliminating the stored message if the response message includes an incorrect response to the challenge.

54. A machine readable storage medium as defined in claim 53, wherein the response message is identified as being a response message through the presence of the second temporary identifier in the response message

55. A machine readable storage medium as defined in claim 531 wherein the challenge identifier includes a generic challenge identifier.

56. A machine readable storage medium as defined in claim 55, wherein the response message is identified as being a response message through the presence of the generic challenge identifier in the response message.

57. A machine readable storage medium as defined in claim 56, wherein the response message is identified as being a response message through the presence of both the generic challenge identifier and the second temporary identifier in the response message.

58. A machine readable storage medium as defined in claim 57, wherein the incoming electronic message, the challenge message and the response message are electronic mail messages.

59. A machine readable storage medium as defined in claim 57, wherein said identifier generating module automatically updates the first temporary identifier at random time intervals.

60. A machine readable storage medium as defined in claim 57, wherein said identifier generating module automatically updates the first temporary identifier at a fixed time interval.

61. A machine readable storage medium as defined in claim 57, wherein the predetermined identifier is included in a destination field of an electronic mail message.

62. A machine readable storage medium as defined in claim 57, wherein the first temporary identifier is included in a destination field of an electronic mail message.

63. A machine readable storage medium as defined in claim 57, wherein the identifier generating module provides the first temporary identifier at least on a basis of a moment at which the first temporary identifier is provided.

64. A machine readable storage medium as defined in claim 57, wherein the identifier generating module provides the first temporary identifier at least on a basis of a destination to which an outgoing electronic message is sent.

65. A machine readable storage medium as defined in claim 57, wherein the identifier generating module provides the first temporary identifier at least on a basis of a content of an outgoing electronic message that is sent.

66. A system for filtering an incoming electronic mail message sent by a sender and addressed to an intended user, said system comprising:
a. an identifier generating means for providing a first temporary identifier;
b. an input means for receiving the incoming electronic mail message from the sender;
c. a filtering means for processing the incoming electronic mail message to detect the presence of the first temporary identifier therein and for, upon detection of the first temporary identifier, allowing a delivery of the incoming electronic mail message to the user.

67. A system as defined in claim 66, wherein said filtering means is further for processing the incoming electronic mail message to detect the presence of a predetermined identifier in the incoming electronic mail message and allowing a delivery of the incoming electronic mail message to the user upon detection of the predetermined identifier.

68. A system as defined in claim 67, wherein said identifier generating means, said input means and said filtering means reside on a server.

69. A system as defined in claim 68, further comprising:
a. an electronic mail interface means for displaying incoming electronic mail messages to the user and for producing electronic mail messages from user inputs; and
b. an output means for delivering electronic mail messages to said electronic mail interface means.

70. A system as defined in claim 69, wherein:
a. said output means resides on said server; and
b. said electronic mail interface means resides on a client in electronic messaging communication with said server.

71. A system as defined in claim 70, wherein said electronic mail interface means includes the first temporary identifier in at least some of the outgoing electronic mail messages produced from the user input.

72. A system as defined in claim 70, wherein said electronic mail interface means includes the first temporary identifier in outgoing electronic mail messages produced from the user input that satisfy at least one predetermined diffusion criteria.

73. A system as defined in claim 72, wherein the at least one predetermined diffusion criteria includes sending the outgoing electronic message to a destination present in a predetermined list of destinations.

74. A system as defined in claim 73, wherein the predetermined list of destinations includes a contacts list.

75. A system as defined in claim 70, wherein said electronic mail interface means includes the first temporary identifier in outgoing electronic mail messages produced from the user input only if the predetermined identifier is excluded from the outgoing electronic message.

76. A system as defined in claim 70, wherein said electronic mail interface means includes the first temporary identifier in every outgoing electronic mail messages produced from the user input.

77. A system as defined in claim 70, wherein said filtering means, upon both a non-satisfaction of the at least one predetermined input filtering criteria and an absence of the first temporary identifier in the incoming electronic message, is further for:
a. storing the incoming electronic mail message;
b. sending a challenge mail message associated with the stored electronic mail message to the sender, wherein the challenge mail message is designed to be answered by a person and not a machine, the challenge mail message including a challenge and a challenge identifier.

78. A system as defined in claim 77, wherein:
a. said input means is further for receiving a response mail message in response to the challenge mail message;
b. said filtering means if further for identifying the response mail message as being a response mail message through the presence of at least part of the challenge identifier in the response mail message and allowing delivery of the stored message to the user if the response mail message includes a correct response to the challenge.

79. A system as defined in claim 78, wherein said filtering means if further for eliminating the stored message if the response mail message includes an incorrect response to the challenge.

80. A system as defined in claim 77, wherein said electronic mail interface means is further for adding the sender to a predetermined list of destinations if the response mail message includes a correct response to the challenge, wherein outgoing electronic mail messages sent by the user to a destination included in the predetermined list of destinations include the predetermined identifier.

81. A system as defined in claim 80, wherein said identifier generating means automatically updates the first temporary identifier at random time intervals.

82. A system as defined in claim 80, wherein said identifier generating means automatically updates the first temporary identifier at a fixed time intervals.

83. A system as defined in claim 80, wherein said electronic mail interface means includes the predetermined identifier in a destination field of outgoing electronic mail messages.

84. A system as defined in claim 80, wherein said electronic mail interface means includes the first temporary identifier in a destination field of outgoing electronic mail messages.

85. A system as defined in claim 6, further comprising the step of automatically updating a predetermined identifier further to a reception of an identifier update message, the identifier update message including a new predetermined identifier associated with a predetermined destination
